(19) United States
(12) Patent Application Publication
(10) Pub. No.: US 2026/0269520 A1
(43) Pub. Date: Sep. 10, 2026

(54) CONNECTOR AND CONNECTOR ASSEMBLY

(71) Applicant: Xuancheng Luxshare Precision Industry Co.,Ltd, Xuancheng City (CN)

(72) Inventors: Ankang SHENG, Xuancheng City (CN); Weihe HONG, Xuancheng City (CN); Haomai YIN, Xuancheng City (CN)

(73) Assignee: Xuancheng Luxshare Precision Industry Co.,Ltd, Xuancheng City (CN)

(21) Appl. No.: 19/368,372

(22) Filed: Oct. 24, 2025

(30) Foreign Application Priority Data
Mar. 10, 2025 (CN) 202520404914.8

(51) Int. Cl. H01R 13/627; H01R 12/77; H01R 13/428; H01R 13/502; H01R 13/52

(52) U.S. Cl. CPC H01R 13/6273; H01R 12/774; H01R 13/428; H01R 13/502; H01R 13/5202; H01R 13/5205

(57) ABSTRACT

A connector includes an insulating body, first terminals, a first sealing ring, and a second sealing ring. The insulating body is provided with multiple first mounting holes, and a first mounting hole has a first hole opening and a second hole opening opposite to each other. The multiple first terminals are inserted into the first mounting holes via first hole openings respectively, and the first terminals are connected to first cables passing through the first mounting holes via the first hole openings respectively. The first sealing ring is secured to a side of the insulating body facing the first hole openings and abuts against the insulating body, the first sealing ring is provided with multiple through holes, and the first cables pass through the through holes respectively and abut against the first sealing ring. The second sealing ring is sleeved outside the insulating body.

### CROSS-REFERENCE TO RELATED APPLICATIONS

This application claims priority to Chinese Patent Application No. 202520404914.8 filed Mar. 10, 2025, the disclosure of which is incorporated herein by reference in its entirety.

### TECHNICAL FIELD

The present application relates to the technical field of connectors and, in particular, to a connector and a connector assembly.

### BACKGROUND

A connector assembly serves as a device for connecting two active components and for transmitting currents or signals. The connector assembly includes a connector and a mating connector that fit together. With an increasing demand for communication between electronic devices, the need for connections and wiring between the electronic devices is also growing. To reduce the space cost of connector assemblies used for the connections between the electronic devices and improve the connection efficiency, the number of terminals in connectors has also been steadily increasing.

Terminals are typically inserted into mounting holes disposed on insulating bodies. Inevitably, there is a gap between the mounting hole and a cable connected to the terminal, making water or dust enter the connector assembly easily, which can degrade the performance of the connector assemblies. As the number of terminals continues to rise, improving the sealing performance of the connector assembly has become an urgent issue to be addressed.

### SUMMARY

The present application provides a connector and a connector assembly.

The present application adopts the technical solutions below.

A connector includes an insulating body, multiple first terminals, a first sealing ring, and a second sealing ring. The insulating body is provided with multiple first mounting holes extending in a same direction, where a first mounting hole of the multiple first mounting holes has a first hole opening and a second hole opening that are arranged opposite to each other; the multiple first terminals are inserted into the multiple first mounting holes via first hole openings respectively, and the plurality of first terminals are connected to multiple first cables passing through the multiple first mounting holes via the first hole openings respectively; the first sealing ring is secured to a side of the insulating body facing the first hole openings and is arranged to abut against the insulating body, where the first sealing ring is provided with multiple through holes in one-to-one correspondence with the multiple first cables, and the first cables are arranged to pass through the multiple through holes respectively and abut against the first sealing ring; the second sealing ring is sleeved outside the insulating body and is arranged to abut against a mating connector sleeved outside the insulating body.

In one or more embodiments, the insulating body is provided with a mounting groove communicating with the multiple first mounting holes, and the first sealing ring is mounted within the mounting groove and is arranged to abut against a groove wall of the mounting groove.

In one or more embodiments, the first sealing ring includes a sealing body, multiple first annular protrusions, and multiple second annular protrusions, where the multiple first annular protrusions are spaced apart on an exterior of the sealing body along a length direction of the first mounting hole, and the multiple second annular protrusions are spaced apart on a hole wall of a through hole of the plurality of through holes along a length direction of the through hole.

In one or more embodiments, an inner circumferential wall of the second sealing ring is provided with multiple third annular protrusions, and an outer circumferential wall of the second sealing ring is provided with multiple fourth annular protrusions; the multiple third annular protrusions are spaced apart along a length direction of the first mounting hole, and the multiple fourth annular protrusions are spaced apart along the length direction of the first mounting hole.

In one or more embodiments, the connector further includes a housing securely sleeved outside the insulating body, where a gap is provided between the housing and the insulating body for the mating connector to be inserted into, and the housing is further provided with multiple exit holes for the first cables to pass through.

In one or more embodiments, the connector further includes a third locking member, where the third locking member is inserted into the housing and is configured to lock the mating connector.

In one or more embodiments, a third fastener is disposed on an inner wall of the housing and mates with the mating connector, and the third locking member is configured to restrict the third fastener from disengaging from the mating connector.

In one or more embodiments, the connector further includes a second terminal, where the insulating body is provided with a second mounting hole, and the second terminal is inserted into the second mounting hole.

In one or more embodiments, the plurality of first terminals are low-voltage terminals, and the second terminal is a terminal for transmitting an Ethernet signal.

A connector assembly includes the preceding connector and the mating connector mating with the connector.

### BRIEF DESCRIPTION OF DRAWINGS

FIG. 1 is a view illustrating the structure of a connector taken from one angle according to an embodiment of the present application.

FIG. 2 is a view illustrating the structure of a connector taken from another angle according to an embodiment of the present application.

FIG. 3 is an exploded view of a connector according to an embodiment of the present application.

FIG. 4 is a side view of a connector according to an embodiment of the present application.

FIG. 5 is a section view taken along A-A of FIG. 4.

FIG. 6 is a section view taken along B-B of FIG. 4 when a second locking member is at the pre-mounting position.

FIG. 7 is a section view taken along B-B of FIG. 4 when a second locking member is at the final locking position.

FIG. 8 is a section view taken along C-C of FIG. 4.

FIG. 9 is a rear view of a connector without a housing.

FIG. 10 is a section view taken along D-D of FIG. 9 when a first locking member is at the pre-mounting position.

FIG. 11 is a section view taken along D-D of FIG. 9 when a first locking member is at the final locking position.

FIG. 12 is a view illustrating the structure of an insulating body taken from one angle according to an embodiment of the present application.

FIG. 13 is a view of an insulating body taken from another angle according to an embodiment of the present application.

FIG. 14 is a view illustrating the structure of a second locking member according to an embodiment of the present application.

FIG. 15 is a view illustrating the structure of a second terminal according to an embodiment of the present application.

FIG. 16 is a view illustrating the structure of a first locking member according to an embodiment of the present application.

FIG. 17 is a view illustrating the structure of a first terminal according to an embodiment of the present application.

FIG. 18 is a rear view of a connector with a housing according to an embodiment of the present application.

FIG. 19 is a section view taken along E-E of FIG. 18 when a third locking member is at the pre-mounting position.

FIG. 20 is a section view taken along E-E of FIG. 18 when a third locking member is at the final locking position.

FIG. 21 is a view illustrating the structure of a third locking member according to an embodiment of the present application.

FIG. 22 is a view illustrating the structure of a housing taken from one angle according to an embodiment of the present application.

FIG. 23 is a view illustrating the structure of a housing taken from another angle according to an embodiment of the present application.

FIG. 24 is a view illustrating the structure of a first sealing ring according to an embodiment of the present application.

FIG. 25 is a view illustrating the structure of a second sealing ring according to an embodiment of the present application.

### REFERENCE LIST

1 insulating body

11 second mounting hole

111 third hole opening

112 fourth hole opening

12 first mounting hole

121 first hole opening

122 second hole opening

13 second fastener

131 first elastic arm

132 first locking block

14 first fastener

141 second elastic arm

142 second locking block

15 first stop block

151 first stop surface

152 guide groove

16 second stop block

161 third stop surface

17 first positioning block

18 securing groove

19 second slot hole

110 mounting groove

120 third positioning block

2 second terminal

21 front shielding shell

211 first abutting surface

212 guide block

213 second abutting surface

22 rear shielding shell

221 first recess

3 first terminal

31 second recess

32 avoidance groove

33 third abutting surface

4 second locking member

41 sleeve portion

411 avoidance notch

42 insertion portion

421 step surface

422 second stop surface

43 first slot hole

5 first locking member

51 cantilever portion

511 locking portion

512 mounting portion

513 interference relief groove

514 second positioning block

515 avoidance hole

52 connecting portion

521 force applying groove

6 housing

61 operation hole

62 third slot hole

63 exit hole

64 third fastener

641 third elastic arm

642 connecting rod

643 third recess

644 connecting block

65 insertion hole

66 fourth positioning block

7 third locking member

71 locking arm

72 locking groove

73 positioning arm

731 fourth slot hole

74 sliding plate

8 first sealing ring

81 first annular protrusion

82 second annular protrusion

83 sealing body

84 through hole

9 second sealing ring

91 third annular protrusion

92 fourth annular protrusion

10 second cable

20 first cable

30 end cover

### DETAILED DESCRIPTION

The present application is further described below in detail in conjunction with the drawings and embodiments. The embodiments described herein are intended to illustrate and not to limit the present application. Additionally, for ease of description, only part, not all, of structures related to the present application are illustrated in the drawings.

In the description of the present application, unless otherwise expressly specified and limited, the term "connected to each other", "connected", or "secured" is to be construed in a broad sense, for example, as securely connected, detachably connected, or integrated; mechanically connected or electrically connected; directly connected to each other or indirectly connected to each other via an intermediary; or internally connected or an interactional relationship between two elements. For those of ordinary skill in the art, specific meanings of the preceding terms in the present application may be understood based on specific situations.

In the present application, unless otherwise expressly specified and limited, when a first feature is described as being "on" or "below" a second feature, the first feature and the second feature may be in direct contact or be in contact via another feature between the two features instead of being in direct contact. Moreover, when the first feature is described as being "on", "above", or "over" the second feature, the first feature is right on, above, or over the second feature, the first feature is obliquely on, above, or over the second feature, or the first feature is simply at a higher level than the second feature. When the first feature is described as being "under", "below", or "underneath" the second feature, the first feature is right under, below, or underneath the second feature, the first feature is obliquely under, below, or underneath the second feature, or the first feature is simply at a lower level than the second feature.

In the description of this embodiment, orientations or position relations indicated by terms such as "above", "below", "left", and "right" are based on the drawings. These orientations or position relations are intended only to facilitate the description and simplify an operation and not to indicate or imply that a device or element referred to must have such particular orientations or must be configured or operated in such particular orientations. Thus, these orientations or position relations are not to be construed as limiting the present application. Additionally, terms "first" and "second" are used for distinguishing between descriptions and have no special meanings.

Embodiments of the present application provide a connector and a connector assembly, which can solve the problem of poor sealing performance of the connector and the connector assembly with multiple terminals. The connector assembly includes the connector and a mating connector mating with the connector. The connector is connected to a device through a cable, and the mating connector is disposed on a device body of another device. The device where the mating connector is located may be, but is not limited to, a vehicle-mounted processing device such as a domain controller or IVI, and the connector may be, but is not limited to, a vehicle-mounted device connected to the vehicle-mounted processing device, such as lidar or a gateway.

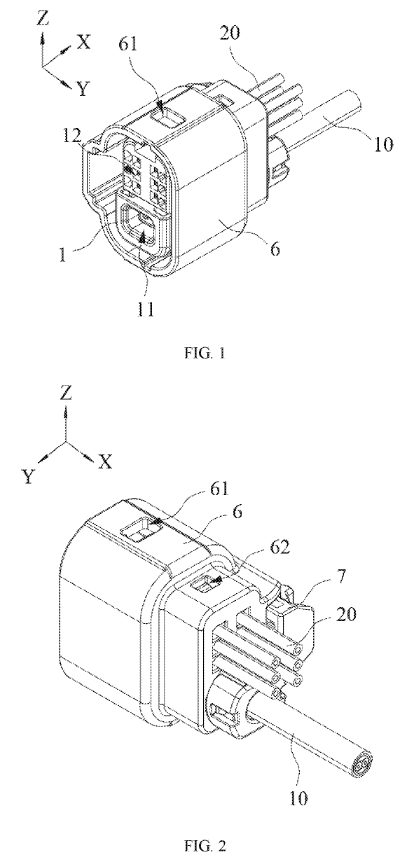

Referring to FIGS. 1, 3, 8, and 24, the connector includes an insulating body 1, one or more first terminals 3, a first sealing ring 8, and a second sealing ring 9. The insulating body 1 is provided with one or more first mounting holes 12 extending in the same direction, and a first mounting hole 12 has a first hole opening 121 and a second hole opening 122 that are arranged opposite to each other. The first terminals 3 are inserted into the first mounting holes 12 via first hole openings 121 in one-to-one correspondence, and first mating terminals on the mating connector that are adapted to the first terminals 3 can be electrically connected to the first terminals 3 through second hole openings 122 respectively. Any first terminal 3 is connected to a first cable 20. One or more first cables 20 pass through the insulating body 1 via the first hole openings 121 respectively. The first sealing ring 8 is secured to a side of the insulating body 1 facing the first hole openings 121 and abuts against the insulating body 1, and the first sealing ring 8 is provided with one or more through holes 84 in one-to-one correspondence with the first cables 20. The first cables 20 pass through the through holes 84 respectively and abut against the inner walls of the through holes 84 respectively. The second sealing ring 9 is sleeved outside the insulating body 1. A housing of the mating connector can be sleeved on the insulating body 1 and abut against the second sealing ring 9.

In the connector and the connector assembly, the first sealing ring 8 is used for sealing the first cables 20 and the insulating body 1, and the second sealing ring 9 is used for sealing the connector and the mating connector, thereby improving the sealing performance of the entire connector assembly and achieving good dustproof and waterproof effects. Moreover, the first sealing ring 8 can simultaneously seal multiple first terminals 3 and the insulating body 1, reducing the assembly difficulty of the connector and the connector assembly.

Referring to FIG. 8, the side of the insulating body 1 facing the first hole openings 121 is provided with a mounting groove 110 communicating with the first mounting holes 12, and the first sealing ring 8 is embedded into the mounting groove 110 and abuts against the groove wall of the mounting groove 110. The arrangement of the mounting groove 110 improves the stability of the connection between the first sealing ring 8 and the insulating body 1.

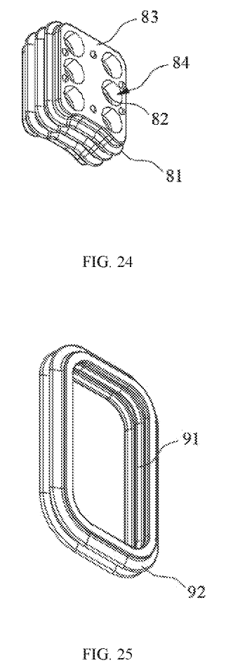

Referring to FIG. 24, to improve the sealing performance of the first sealing ring 8, the first sealing ring 8 includes a sealing body 83 and multiple first annular protrusions 81 spaced apart on the outer wall surface of the sealing body 83 along the length direction of the first mounting hole 12 to increase the contact area with the groove sidewall of the mounting groove 110 and improve the sealing performance. Moreover, multiple second annular protrusions 82 are spaced apart on the hole wall of a through hole 84 along the length direction of the through hole 84 to increase the contact area with a first cable 20 and improve the sealing performance. In this embodiment, the length direction of the through hole 84 is consistent with the length direction of the first mounting hole 12 to reduce the bending deformation of the first cable 20.

Referring to FIG. 25, the inner circumferential wall of the second sealing ring 9 is provided with multiple third annular protrusions 91 and the outer circumferential wall of the second sealing ring 9 is provided with multiple fourth annular protrusions 92; the multiple third annular protrusions 91 are spaced apart along the length direction of the first mounting hole 12, and the multiple fourth annular protrusions 92 are spaced apart along the length direction of the first mounting hole 12. This increases the contact area between the second sealing ring 9 and the insulating body 1 and the mating connector, thereby improving the sealing performance.

Referring to FIGS. 1 to 3, 6, and 12, the connector further includes a second terminal 2, a second locking member 4, and a first locking member 5. The first locking member 5, the second locking member 4, and the insulating body 1 are all injection molded. The insulating body 1 is further provided with a second mounting hole 11. The second terminal 2 is inserted into the second mounting hole 11. A second fastener 13 is disposed within the second mounting hole 11. One or more first fasteners 14 are disposed within one or more first mounting holes 12 respectively. The second fastener 13 is arranged to lock the second terminal 2 at a preset position in the second mounting hole 11. The first fasteners 14 are arranged to lock the first terminals 3 at preset positions in the first mounting holes 12 respectively. The second locking member 4 and the first locking member 5 are detachably inserted into the insulating body 1 and each of the second locking member and the first locking member has a pre-mounting position and a final locking position. The second locking member 4 at the pre-mounting position allows the second terminal 2 to be inserted into the second mounting hole 11, and the second locking member 4 at the final locking position enables the second fastener 13 to keep locking the second terminal 2. The first locking member 5 at the pre-mounting position allows the first terminals 3 to be inserted into the first mounting holes 12 or pulled out from the first mounting holes 12, and the first locking member 5 at the final locking position can lock the first terminals 3.

The preceding connector utilizes the second fastener 13 to initially lock the second terminal 2 first, and then utilizes the second locking member 4 to limit the position of the second fastener 13 to enable the second fastener 13 to keep locking the second terminal 2, thereby improving the stability of the connection between the second terminal 2 and the insulating body 1. Moreover, the first fasteners 14 provide the initial locking of the first terminals 3, and the first locking member 5 offers a secondary locking of the first terminals 3, improving the stability of the connection between the first terminals 3 and the insulating body 1 and thus improving the assembly stability of the entire connector. Furthermore, the first locking member 5, the second locking member 4, and the insulating body 1 are all injection molded so that the first locking member 5 and the second locking member 4 can be assembled on the insulating body 1 in advance and placed at the pre-mounting position before being transported, thereby reducing the possibility of losing the first locking member 5 and the second locking member 4 and reducing the difficulty of later assembly.

In this embodiment, the second terminal 2 is connected to a second cable 10 and has a different function from the first terminal 3. For example, if the second terminal 2 is a signal terminal for transmitting an Ethernet signal, the second cable 10 connected to the second terminal 2 is a high-speed signal cable; if the first terminal 3 is a low-voltage terminal for transmitting, for example, a low-speed controller area network (CAN) signal, the first cable 20 connected to the first terminal 3 is a low-voltage cable. The second mounting hole 11 and a first mounting hole 12 have different internal spaces and the internal space of the second mounting hole 11 is larger than the internal space of the first mounting hole 12 to enable the second terminal 2 to be adapted to the first terminal 3.

To enable sealing between the second terminal 2 and the insulating body 1, a sealing member abutting against the insulating body 1 may also be securely sleeved on the second terminal 2, which is described in detail herein.

Referring to FIGS. 1 and 2, the second mounting hole 11 and the first mounting hole 12 both extend along the first direction (the direction X and the reverse direction of the direction X in FIG. 1, where the direction X is the forward direction of the first direction, and the reverse direction of the direction X is the reverse direction of the first direction), and the second mounting hole 11 and the first mounting hole 12 are spaced apart along the third direction perpendicular to the first direction (the direction Z and the reverse direction of the direction Z in FIG. 1, where the direction Z is the forward direction of the third direction, and the reverse direction of the direction Z is the reverse direction of the third direction). Based on the limitation on the size of the internal space of the second mounting hole 11 and the limitation on the size of the internal space of the first mounting hole 12, to reduce the difficulty of assembling the second locking member 4 and the first locking member 5 on the insulating body 1, the second locking member 4 achieves switching between the pre-mounting position and the final locking position by moving along the first direction, and the first locking member 5 achieves switching between the pre-mounting position and the final locking position by moving along the third direction.

Exemplarily, one second mounting hole 11 is provided, and six first mounting holes 12 are provided. The six first mounting holes 12 are arranged in two rows symmetrical along the second direction (the direction Y and the reverse direction of the direction Y in FIG. 1, where the direction Y is the forward direction of the second direction, and the reverse direction of the direction Y is the reverse direction of the second direction). Any row of first mounting holes 12 includes three first mounting holes 12 spaced apart along the third direction. The number of first terminals 3 is the same as the number of first mounting holes 12. Six first terminals 3 are also provided. In this case, the first locking member 5 moving along the third direction can lock the multiple first terminals 3 simultaneously. The second direction is perpendicular to the first direction and the third direction.

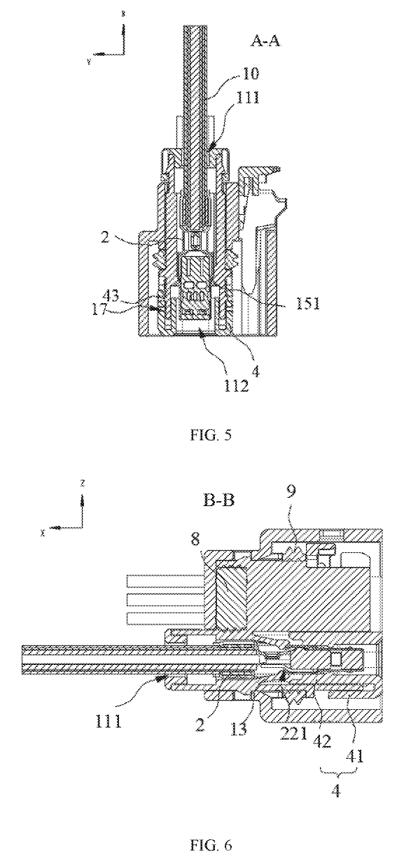

Referring to FIGS. 5 to 7, the second mounting hole 11 is provided with a third hole opening 111 and a fourth hole opening 112 that are arranged opposite to each other along the first direction. The third hole opening 111 is provided on a forward side of the fourth hole opening 112 along the first direction. The second terminal 2 can be inserted into the second mounting hole 11 via the third hole opening 111 and moved toward the fourth hole opening 112. A second mating terminal adapted to the second terminal 2 and located on the mating connector can be electrically connected to the second terminal 2 through the fourth hole opening 112. The first stop surface 151 is disposed on a side of the inner wall of the second mounting hole 11 facing the fourth hole opening 112. The first stop surface 151 can abut against the first abutting surface 211 on the second terminal 2, preventing the second terminal 2 from continuing to move toward the fourth hole opening 112, so that the second terminal 2 can be inserted into the preset position of the second mounting hole 11.

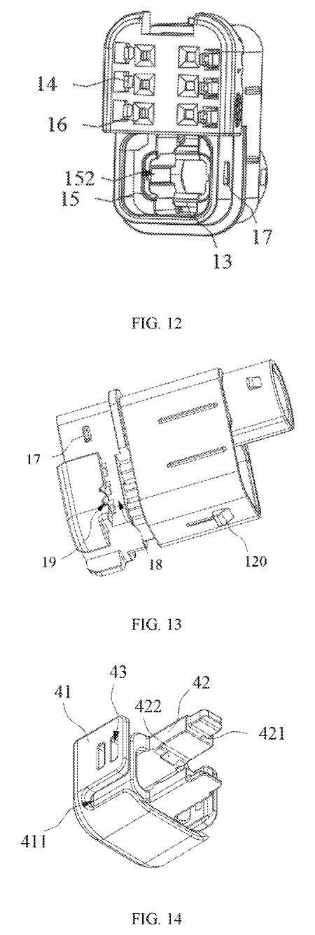

Illustratively, referring to FIGS. 5 and 12, an inner wall surface of the second mounting hole 11 is provided with two first stop blocks 15 opposite to each other along the second direction. A first stop surface 151 is formed on an inner side surface of the first stop block 15. The first stop surface 151 is gradually inclined in a direction away from the hole wall of the second mounting hole 11 from one end of the first stop surface 151 facing the third hole opening 111 to the other end of the first stop surface 151 facing away from the third hole opening 111. Correspondingly, the first abutting surface 211 is also inclined.

Referring to FIGS. 6, 7, and 15, the outer wall surface of the second terminal 2 is provided with a first recess 221. The second fastener 13 includes a first elastic arm 131 and a first locking block 132 that are integrally molded. One end of the first elastic arm 131 facing the third hole opening 111 is connected to the hole wall of the second mounting hole 11, and the other end of the first elastic arm 131 gradually moves away from the hole wall of the second mounting hole 11 in the direction toward the fourth hole opening 112. The first locking block 132 is disposed on a side of the first elastic arm 131 facing away from the hole wall of the second mounting hole 11. The first locking block 132 is snap-fit into the first recess 221.

The second terminal 2 can press the second fastener 13 after being inserted into the second mounting hole 11 via the third hole opening 111. The first elastic arm 131 deforms to drive the first locking block 132 to move toward the hole wall of the second mounting hole 11 until the first locking block 132 is locked into the first recess 221. At this time, the first stop surface 151 abuts against the first abutting surface 211, and the second fastener 13 locks the second terminal 2 to prevent the second terminal 2 from moving toward the third hole opening 111.

Illustratively, two second fasteners 13 are symmetrically disposed within the second mounting hole 11 along the third direction to improve the locking stability of the second fasteners 13 on the second terminal 2. Illustratively, the two second fasteners 13 are disposed within two gaps formed by the two first stop blocks 15 respectively and connected to the first stop blocks 15 to improve the structural strength of the second fasteners 13.

Illustratively, a side of the first locking block 132 facing the third hole opening 111 is provided with the first guide surface. The first guide surface gradually moves away from the hole wall of the second mounting hole 11 from a side of the first guide surface facing the third hole opening 111 to the other side of the first guide surface facing away from the third hole opening 111 to reduce the difficulty of crossing the first locking block 132 for the second terminal 2 when an end of the second terminal 2 inserted into the second mounting hole 11 moves toward the fourth hole opening 112.

In this embodiment, to reduce the difficulty of inserting the second terminal 2 into the second mounting hole 11, the area of the third hole opening 111 is larger than the maximum cross-sectional area of the second terminal 2. On this basis, the connector further includes an end cover 30. The end cover 30 is mounted on the insulating body 1 and located on a side of the third hole opening 111 of the second mounting hole 11. The end cover 30 is provided with a threading hole for the second cable 10 to pass. The area of the threading hole is smaller than the area of the third hole opening 111.

After the second terminal 2 connected to the second cable 10 is inserted into the second mounting hole 11, the end cover 30 is mounted on the insulating body 1, reducing the possibility of shaking the second cable 10 and improving the stability of the entire connector. Illustratively, the end cover 30 is snap-fit into the insulating body 1 to facilitate the maintenance and replacement of the second terminal 2.

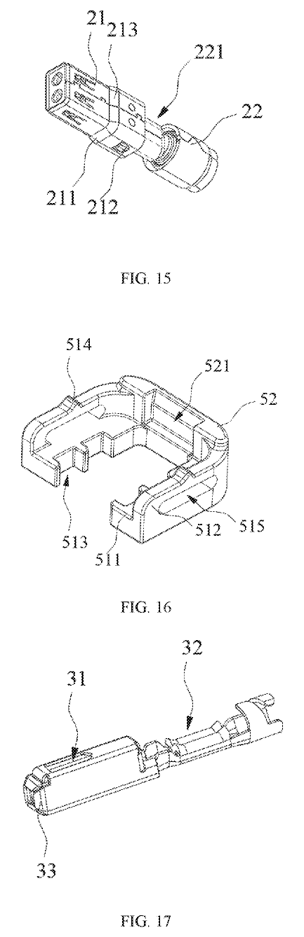

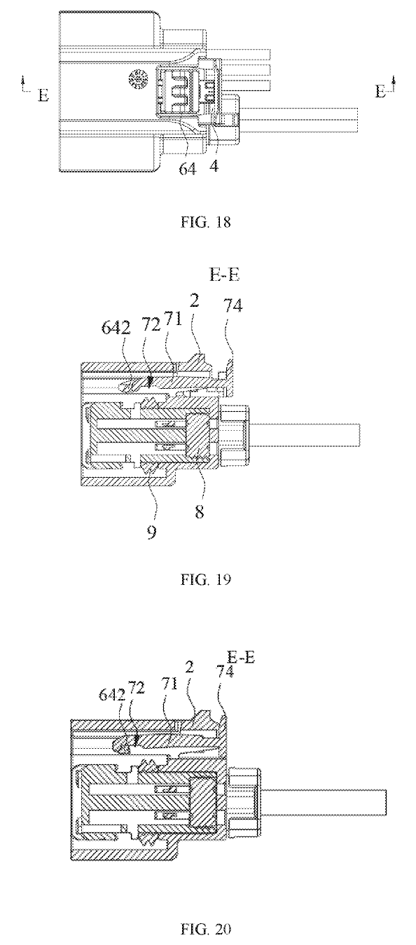

Referring to FIG. 15, the second terminal 2 includes a front shielding shell 21, an inner conductor, a wire clamp, and a rear shielding shell 22. A rear end of the front shielding shell 21 is sleeved on the rear shielding shell 22 and crimped with the rear shielding shell 22. The inner conductor is located within the front shielding shell 21 and is configured to be electrically connected to the second mating terminal and the second cable 10. The wire clamp is located within the rear shielding shell 22 and is configured to secure one end of the second cable 10 within the rear shielding shell 22. The front shielding shell 21 is provided with a small-diameter section and a large-diameter section in sequence in the reverse direction of the first direction. The first abutting surface 211 is formed between the large-diameter section and the small-diameter section. The rear shielding shell 22 is in the shape of a dumbbell. The first recess 221 is an annular groove formed on the rear shielding shell 22. The annular groove is located outside the front shielding shell 21.

In other embodiments, the first recess 221 may be disposed on the first elastic arm 131, and the first locking block 132 may be disposed on the second terminal 2.

Referring to FIGS. 12 and 15, to prevent the second terminal 2 from being inserted into the second mounting hole 11 too far and causing damage to the second terminal 2 or the insulating body 1, in this embodiment, the inner side surface of a first stop block 15 is also formed with a guide groove 152 extending in the first direction. A side of the guide groove 152 facing the fourth hole opening 112 is closed. The outer wall surface of the second terminal 2 is provided with a guide block 212 that is in a slidable fit into the guide groove 152. When the second terminal 2 is at the preset position within the second mounting hole 11, the guide block 212 abuts against the groove wall at an end of the guide groove 152 facing the fourth hole opening 112. Illustratively, the guide block 212 is disposed on the outer wall surface of the large-diameter section.

Referring to FIG. 14, the second locking member 4 includes a sleeve portion 41 and an insertion portion 42. The sleeve portion 41 is connected to the insertion portion 42 and located outside the insertion portion 42. A clamping space having an opening facing the third hole opening 111 is formed between the sleeve portion 41 and the insertion portion 42. The insertion portion 42 is inserted into the second mounting hole 11 via the fourth hole opening 112. The sleeve portion 41 is sleeved on the outside of the insulating body 1. In this manner, the sidewall of the insulating body 1 is clamped within the clamping space.

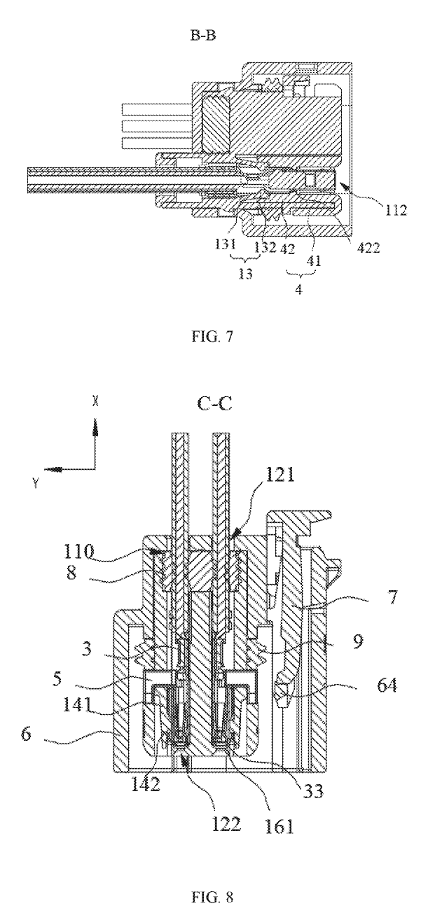

The second locking member 4 is inserted into the second mounting hole 11 via the fourth hole opening 112. Referring to FIGS. 6 and 7, when the second locking member 4 is at the pre-mounting position, the second locking member 4 and the second fasteners 13 are spaced apart in the first direction, and the second locking member 4 does not interfere with the deformation of the second fasteners 13 so that the second terminal 2 can be inserted into the preset position of the second mounting hole 11 via the third hole opening 111; when the second locking member 4 is at the final locking position, the second fasteners 13 move toward the second terminal 2 along the first direction, the inner side of the insertion portion 42 abuts against sides of the second fasteners 13 facing away from the second terminal 2, and the second fasteners 13 are limited by the insertion portion 42 and are no longer capable of deforming toward the hole wall of the second mounting hole 11 and thereby keeps snap-fit into the second terminal 2, thereby maintaining the stability of the insertion of the second terminal 2 into the second mounting hole 11. When the second locking member 4 is at the final locking position, the end surface of the insulating body 1 abuts against a side of the clamping space facing away from the opening, preventing the second locking member 4 from continuing to move toward the third hole opening 111.

Illustratively, referring to FIG. 14, the step surface 421 is formed at an end of the insertion portion 42 inserted into the second mounting hole 11. When the second locking member 4 is at the final locking position, the second fasteners 13 abut against the step surface 421 to define the final locking position of the second locking member 4, better reducing the possibility that the second locking member 4 is excessively inserted into the second mounting hole 11.

Moreover, the second stop surface 422 is formed on a side of the second locking member 4 facing the second terminal 2. The second stop surface 422 gradually moves away from the hole wall of the second mounting hole 11 from one end of the second stop surface 422 facing the third hole opening 111 to the other end of the second stop surface 422 facing away from the third hole opening 111. The second abutting surface 213 that is in a fit into the second stop surface 422 is formed on the outer wall surface of the second terminal 2. When the second locking member 4 is at the final locking position, the second stop surface 422 abuts against the second abutting surface 213, and cooperates with the first stop surface 151 and the first abutting surface 211 to better prevent the second terminal 2 from moving toward the fourth hole opening 112.

Illustratively, two opposite second stop surfaces 422 are formed on the inner sidewall of the second locking member 4. Correspondingly, two second abutting surfaces 213 are also formed, and are also formed between the small-diameter section of the front shielding shell 21 and the large-diameter section of the front shielding shell 21. That is, the second abutting surface 213 and the first abutting surface 211 jointly form a conical surface connecting the large-diameter section and the small-diameter section.

Referring to FIGS. 5 and 9, to facilitate observing whether the second locking member 4 is at the pre-mounting position or the final locking position and improve the stability of assembling the second locking member 4 on the insulating body 1, a first positioning block 17 is also disposed on one of the second locking member 4 and the insulating body 1, and a first slot hole 43 that is snap-fit into the first positioning block 17 is formed on the other one of the second locking member 4 and the insulating body 1. Two first slot holes 43 are provided and spaced apart along the first direction. When the first positioning block 17 is limited in one of the two first slot holes 43 far from the fourth hole opening 112, the second locking member 4 is at the pre-mounting position. When the first positioning block 17 is limited in one of the two first slot holes 43 adjacent to the fourth hole opening 112, the second locking member 4 is at the final locking position.

Exemplarily, the first positioning block 17 is disposed on the insulating body 1, and the first slot holes 43 are formed on the second locking member 4. Illustratively, the cross section of the first positioning block 17 is arranged as an equilateral trapezoid or an equilateral triangle with chamfered corners to reduce the difficulty of the first positioning block 17 entering and leaving the first slot holes 43.

Referring to FIG. 14, to reduce the difficulty of disengaging the second locking member 4 from the insulating body 1, an avoidance notch 411 is formed on the sleeve portion 41, and the avoidance notch 411 extends along the first direction to the end surface of the sleeve portion 41 facing the second terminal 2. When the second locking member 4 is disassembled by applying a force to the sleeve portion 41 in a direction away from the insulating body 1 along the second direction, the first positioning block 17 can be disengaged from the first slot holes 43.

Referring to FIG. 8, the first hole opening 121 and the third hole opening 111 are located on the same side of the insulating body 1, and the third stop surface 161 is formed on a side of the first mounting hole 12 facing the second hole opening 122. The third stop surface 161 can abut against the third abutting surface 33 on the first terminal 3, thereby preventing the first terminal 3 from continuing to move toward the second hole opening 122, so that the first terminal 3 can be inserted into the preset position of the first mounting hole 12.

Illustratively, an annular second stop block 16 is disposed on the side of the first mounting hole 12 facing the second hole opening 122. The third stop surface 161 is formed on a side of the second stop block 16 facing away from the second hole opening 122 and is arranged as a conical surface. The third stop surface 161 gradually expands from one end of the third stop surface 161 facing the second hole opening 122 to the other end of the third stop surface 161 facing away from the second hole opening 122. The conical third abutting surface 33 is formed on the outer wall surface of the first terminal 3. When the third abutting surface 33 abuts against the third stop surface 161, the first terminal 3 is inserted into the preset position of the first mounting hole 12.

Referring to FIGS. 8 and 17, the outer wall surface of the first terminal 3 is provided with a second recess 31, and a first fastener 14 includes a second elastic arm 141 and a second locking block 142 that are integrally molded. One end of the second elastic arm 141 facing the first hole opening 121 is connected to the hole wall of the first mounting hole 12, and the other end of the second elastic arm 141 gradually moves away from the hole wall of the first mounting hole 12 in the direction toward the second hole opening 122. The second locking block 142 is disposed on the side of the second elastic arm 141 facing away from the hole wall of the first mounting hole 12 and is snap-fit into the second recess 31. Illustratively, the second recess 31 is a groove formed on the outer wall surface of the first terminal 3.

The first terminal 3 can press the first fastener 14 after being inserted into the first mounting hole 12 via the first hole opening 121, and the second elastic arm 141 deforms to drive the second locking block 142 to move toward the hole wall of the first mounting hole 12 until the second locking block 142 is locked into the second recess 31. At this time, the third stop surface 161 abuts against the third abutting surface 33, and the first terminal 3 is locked under the cooperation of the first fastener 14.

In this embodiment, a side of the second locking block 142 facing the first hole opening 121 is also provided with a second guide surface. The second guide surface is gradually inclined from a side of the second guide surface facing the first hole opening 121 to the central direction of the first mounting hole 12, thereby reducing the difficulty of crossing the second locking block 142 when an end of the first terminal 3 inserted into the first mounting hole 12 moves toward the second hole opening 122.

The position of the second recess 31 and the position of the second locking block 142 may be interchanged between the second elastic arm 141 and the first terminal 3.

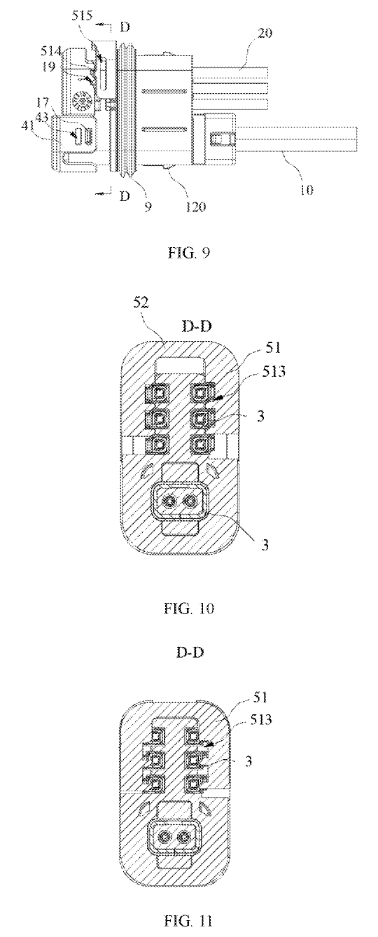

The first locking member 5 is inserted, along the reverse direction of the third direction, into the insulating body 1 from a side facing away from the second terminal 2. Referring to FIGS. 10, 11, and 16, the first locking member 5 is provided with an interference relief groove 513 penetrating the first locking member 5 along the first direction. The interference relief groove 513 on the first locking member 5 at the pre-mounting position faces the first terminal 3 to allow the first terminal 3 to be inserted into or disengaged from the first mounting hole 12. The interference relief groove 513 on the first locking member 5 at the final locking position avoids the first terminal 3, and the first terminal 3 is locked within the first mounting hole 12.

To avoid the first locking member 5 when the first locking member 5 moves along the third direction, the first terminal 3 is provided with one or more avoidance grooves 32. Based on the premise that the first terminals 3 are disposed in rows along the third direction, multiple avoidance grooves 32 located on the first terminals 3 are arranged along the third direction, and the number of interference relief grooves 513 disposed on the first locking member 5 is the same as the number of first terminals 3.

In an example in which two rows of first terminals 3 are disposed symmetrically along the second direction and spaced apart, with continued reference to FIG. 16, the first locking member 5 includes a connecting portion 52 and two cantilever portions 51. The connecting portion 52 extends along the second direction. The two cantilever portions 51 are formed on two opposite sides of the connecting portion 52 along the second direction respectively and are perpendicular to the connecting portion 52 so that the first locking member 5 can be approximately U-shaped. The interference relief grooves 513 are formed on the cantilever portions 51. When the cantilever portions 51 are inserted into the insulating body 1 until the first terminals 3 are at the pre-mounting position, the interference relief grooves 513 on the cantilever portions 51 are in one-to-one correspondence with the first terminals 3, not affecting the insertion of the first terminals 3 into the first mounting holes 12 or the disengagement of the first terminals 3 from the first mounting holes 12. As the cantilever portions 51 continue being inserted into the insulating body 1 until the first terminals 3 are at the final locking position, the interference relief grooves 513 avoid the first terminals 3, preventing the first terminals 3 from moving toward the second hole openings 122.

Referring to FIG. 13, to guide the first terminals 3 to insert into the insulating body 1, the outer wall of the insulating body 1 is provided with two securing grooves 18 extending along the third direction. The two securing grooves 18 communicate with the two rows of first mounting holes 12, respectively. The two cantilever portions 51 are inserted into the insulating body 1 along the two securing grooves 18 respectively.

Further, to facilitate observing whether the first locking member 5 is at the pre-mounting position or the final locking position and improve the stability of assembling the first locking member 5 on the insulating body 1, a second positioning block 514 is also disposed on one of the first locking member 5 and the insulating body 1, and a second slot hole 19 that is snap-fit into the second positioning block 514 is formed on the other one of the first locking member 5 and the insulating body 1. Two second slot holes 19 are provided and spaced apart along the third direction. When the second positioning block 514 is limited in one of the two second slot holes 19 far from the second terminal 2, the first locking member 5 is at the pre-mounting position. When the second positioning block 514 is limited in one of the two second slot holes 19 adjacent to the second terminal 2, the first locking member 5 is at the final locking position.

Exemplarily, the second positioning block 514 is disposed on a cantilever portion 51 of the first locking member 5. Each of the two cantilever portions 51 is provided with a second positioning block 514. The second slot holes 19 corresponding to the second positioning blocks 514 are disposed on slot sidewalls of the two securing grooves 18 respectively.

To reduce the difficulty of the second positioning blocks 514 entering the second slot holes 19, the first locking member 5 is further provided with a strip-shaped avoidance hole 515 extending along the third direction. When the second positioning blocks 514 enter the second slot holes 19, the avoidance hole 515 provides an avoidance space for the deformation of the first locking member 5. Illustratively, the cantilever portion 51 further includes a mounting portion 512 and a locking portion 511 that are L-shaped. The mounting portion 512 and the locking portion 511 are both connected to the connecting portion 52. The mounting portion 512 is slidable in a securing groove 18, and the locking portion 511 is inserted into the first mounting hole 12. The second positioning block 514 and the interference relief groove 513 are provided on the mounting portion 512 and the locking portion 511 respectively, and the avoidance hole 515 is also provided on the mounting portion 512. The arrangement of the avoidance hole 515 reduces the material cost of manufacturing the first locking member 5.

Illustratively, to reduce the difficulty of disassembling the first locking member 5, a force applying groove 521 for convenient force application is also disposed on the connecting portion 52.

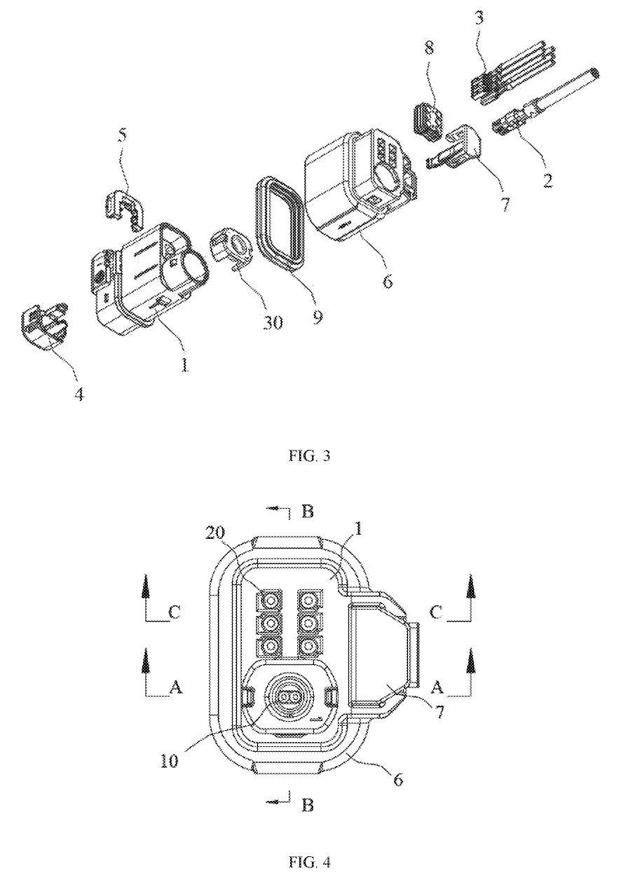

Referring to FIGS. 3 and 8, the connector further includes the first sealing ring 8. The first sealing ring 8 is disposed at the second hole openings 122 of the first mounting holes 12 and is provided with the through holes 84 for the first cables 20 to pass through. The first sealing ring 8 can seal gaps between the second hole openings 122 and the first terminals 3, achieving dustproof and waterproof effects.

Referring to FIGS. 1 to 3, the connector further includes a housing 6 that is securely sleeved outside the insulating body 1 to protect the insulating body 1. A gap exists between the housing 6 and the insulating body 1 for the mating connector to be inserted. Illustratively, the housing 6 has an inner cavity that has an opening toward the reverse direction of the first direction, and the insulating body 1 is located within the inner cavity of the housing 6. An operation hole 61 communicating with the inner cavity of the housing 6 is formed at a position of the housing 6 corresponding to the connecting portion 52 of the first locking member 5. A force toward the second terminal 2 can be applied to the first locking member 5 through the operation hole 61 so that the first locking member 5 can be switched from the pre-mounting position to the final locking position.

The length of the operation hole 61 in the second direction is smaller than the length of the connecting portion 52 in the second direction, that is, the orthographically projected area of the first locking member 5 in the direction of the operation hole 61 is greater than the area of the operation hole 61, thereby preventing the first locking member 5 from disengaging from the insulating body 1 via the operation hole 61 during transportation or from being squeezed to the final locking position during transportation.

Illustratively, referring to FIGS. 9, 22, and 23, the housing 6 is provided with a third slot hole 62, and the insulating body 1 is provided with a third positioning block 120 that is snap-fit into the third slot hole 62. The third positioning block 120 is limited within the third slot hole 62, thereby achieving a detachable connection between the insulating body 1 and the housing 6. Illustratively, two third slot holes 62 are symmetrically provided on the housing 6 along the third direction and two third positioning blocks 120 are provided to improve the stability of the connection between the housing 6 and the insulating body 1. Moreover, an inclined third guide surface is formed at an end of the third positioning block 120 facing away from a slot opening of the housing 6 to reduce the difficulty of clamping the third positioning block 120 into the third slot hole 62. Certainly, the third slot hole 62 may also be provided on the insulating body 1, and the third positioning block 120 may also be disposed on the housing 6.

Referring to FIG. 23, the third hole opening 111 and the first hole opening 121 on the insulating body 1 both face a closed end of the housing 6, and the closed end of the housing 6 is provided with multiple exit holes 63 formed at positions corresponding to the second mounting hole 11 and the first mounting holes 12 and configured for the second cables 10 and the first cables 20 to pass through respectively. The mating connector can be electrically connected to the connector at an open end of the housing 6.

A gap exists between the housing 6 and an end of the insulating body 1 facing the opening of the housing 6 and is configured for the mating connector to be inserted into. To lock the mating connector to the connector, the housing 6 further includes a third fastener 64 disposed on the inner wall of the housing 6. The third fastener 64 is snap-fit into the connector.

Illustratively, referring to FIGS. 19 and 22, the third fastener 64 includes a third elastic arm 641 and a third recess 643. The third elastic arm 641 is connected to the inner wall of the housing 6. The third recess 643 is disposed at an end of the third elastic arm 641 extending toward the slot opening. A third locking block that fits into the third recess 643 is disposed on the mating connector. The third locking block can be locked into the third recess 643 to lock the mating connector.

Illustratively, two third elastic arms 641 are provided and spaced apart along the third direction. The two third elastic arms 641 are connected by a connecting rod 642 so that the preceding third recess 643 is formed between the two third elastic arms 641, and the third locking block is locked into the third recess 643 and abuts against the connecting rod 642.

Referring to FIGS. 19 and 23, an insertion hole 65 is formed at the closed end of the housing 6 for the third fastener 64 to extend into the inner cavity of the housing 6. The insertion hole 65 communicates with the inner cavity of the housing 6. The third elastic arm 641 is connected to the hole wall of the insertion hole 65 through a fulcrum. One end of the third elastic arm 641 connected to the connecting rod 642 extends from the insertion hole 65 into the inner cavity of the housing 6, and the other end of the third elastic arm 641 is located outside the housing 6. The locking of the third fastener 64 to the mating connector can be unlocked by simply pressing the end of the third elastic arm 641 located outside the housing 6.

To better improve the stability between the connector and the mating connector, the connector further includes a third locking member 7. The third locking member 7 also has a pre-mounting position and a final locking position. The third locking member 7 at the pre-mounting position allows the mating connector to be inserted into the preset position within the housing 6. The third locking member 7 at the final locking position makes the third fastener 64 keep locking the mating connector.

With continued reference to FIGS. 19 and 20, the third locking member 7 is inserted into the housing 6 from the closed end of the housing 6 along the first direction, and the third locking member 7 includes a locking arm 71. An end portion of the locking arm 71 of the third locking member 7 at the pre-mounting position is located on a side of the connecting rod 642 facing away from the opening of the housing 6. The locking arm 71 of the third locking member 7 at the final locking position abuts against the outer side of the third fastener 64, thereby preventing the third fastener 64 from moving toward a side facing away from the third locking block. Illustratively, the locking arm 71 is provided with a locking groove 72. The connecting rod 642 can be locked into the locking groove 72 and abut against the groove bottom of the locking groove 72.

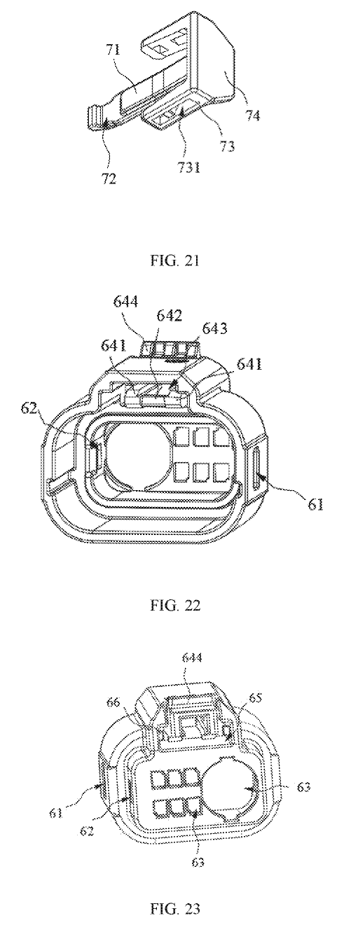

Referring to FIGS. 21 and 23, to improve the stability of assembling the third locking member 7 on the housing 6, a fourth positioning block 66 is also disposed on one of the third locking member 7 and the housing 6, and a fourth slot hole 731 that is snap-fit into the fourth positioning block 66 is formed on the other one of the third locking member 7 and the housing 6. Two fourth slot holes 731 are provided and spaced apart along the first direction. When the fourth positioning block 66 is locked in one of the two fourth slot holes 731 far from the opened end of the housing 6, the third locking member 7 is at the pre-mounting position. When the fourth positioning block 66 is locked in one of the two fourth slot holes 731 adjacent to the opened end of the housing 6, the third locking member 7 is at the final locking position.

Exemplarily, the third slot hole 62 is disposed on the third locking member 7, and the third positioning block 120 is disposed on the housing 6, specifically on the hole wall of the insertion hole 65. Illustratively, the third locking member 7 includes two positioning arms 73 disposed on two opposite sides of the locking arm 71 and spaced apart along the third direction. The two positioning arms 73 are both connected to the locking arm 71 and inserted into the insertion hole 65. The third slot hole 62 is disposed on a positioning arm 73. Moreover, to reduce the difficulty of disassembling and assembling the third locking member 7, the third locking member 7 further includes a sliding plate 74. The sliding plate 74 connects the locking arm 71 and an end portion of the positioning arm 73 located outside the housing 6.

With continued reference to FIG. 23, to facilitate applying a force to the third fastener 64 to disengage the mating connector from the connector, for each third elastic arm 641, an end of the third elastic arm 641 facing away from the connecting rod 642, that is, the end of the third elastic arm 641 located outside the housing 6, is connected to a U-shaped connecting block 644, and two the third elastic arms 641 are connected to two ends of the connecting block 644 respectively. The force applied to the connecting block 644 may make the third elastic arm 641 move away from the third locking block under the action of a lever so that the third elastic arm 641 is disengaged from the third locking block. The locking arm 71 of the third locking member 7 extends through the connecting block 644 and is inserted into the housing 6. In this manner, the unlocking of the third locking member 7 and the unlocking of the third fastener 64 do not interfere with each other.

The preceding connector is assembled in the following manners. The injection-molded first locking member 5 is inserted into the insulating body 1 along the third direction so that the first locking member 5 is at the pre-mounting position; the second sealing ring 9 is sleeved on the insulating body 1; the injection-molded second locking member 4 is inserted into the second mounting hole 11 along the first direction so that the second locking member 4 is at the pre-mounting position; the first sealing ring 8 is mounted within the mounting groove 110; the housing 6 is sleeved on the insulating body 1; the third locking member 7 is inserted into the housing 6; the second terminal 2 and the first terminal 3 are inserted; the second locking member 4 and the first locking member 5 are pushed to the final locking positions when required.

The second terminal 2 can be removed from the second mounting hole 11 and replaced with a new second terminal 2 in the following manners. The second locking member 4 is removed from the insulating body 1 through a tool and then inserted into the second mounting hole 11 through the tool, and then the second fastener 13 is pried toward the hole wall of the second mounting hole 11 through the tool so that the second terminal 2 is disengaged from the insulating body 1, thereby effectively reducing fault maintenance costs. The first terminal 3 can be removed from the first mounting hole 12 and replaced with a new first terminal 3 in the following manners. A force facing away from the insulating body 1 along the third direction may be applied to the first locking member 5 through the force applying groove 521 to remove the first locking member 5 from the insulating body 1; and then a force facing away from the first terminal 3 is applied to the first fastener 14 through the tool entering the first mounting hole 12 to disengage the first fastener 14 from the first terminal 3, and to disengage the first terminal 3 from the insulating body 1. The mating connector can be disengaged from the connector in the following manners. A pressure is applied to the sliding plate 74 of the third locking member 7 to disengage an end of the third locking member 7 snap-fitting into the third fastener 64 from the third fastener 64, and then the third locking member 7 is withdrawn out of the housing 6; then a pressure is applied to the connecting block 644 of the third fastener 64 to disengage an end of the third fastener 64 snap-fitting into the mating connector from the mating connector so that the mating connector is withdrawn out of the housing 6.

Apparently, the preceding embodiments of the present application are examples to clearly describe the present application and are not intended to limit implementations of the present application. Those of ordinary skill in the art can make various apparent modifications, adaptations, and substitutions without departing from the scope of the present application. All embodiments do not need to be and cannot be exhausted herein. Any modification, equivalent substitution, and improvement made within the spirit and principle of the present application fall within the scope of the claims of the present application.

What is claimed is:

1. A connector, comprising:
an insulating body provided with a plurality of first mounting holes extending in a same direction, wherein a first mounting hole of the plurality of first mounting holes has a first hole opening and a second hole opening that are arranged opposite to each other;
a plurality of first terminals, wherein the plurality of first terminals are inserted into the plurality of first mounting holes via first hole openings respectively, and the plurality of first terminals are connected to first cables passing through the plurality of first mounting holes via the first hole openings respectively;
a first sealing ring secured to a side of the insulating body facing the first hole openings and abutting against the insulating body, wherein the first sealing ring is provided with a plurality of through holes in one-to-one correspondence with the plurality of first cables, and the first cables are arranged to pass through the plurality of through holes respectively and abut against the first sealing ring; and
a second sealing ring sleeved outside the insulating body and abutting against a mating connector sleeved outside the insulating body.

2. The connector according to claim 1, wherein the insulating body is provided with a mounting groove communicating with the plurality of first mounting holes, and the first sealing ring is mounted within the mounting groove and is arranged to abut against a groove wall of the mounting groove.

3. The connector according to claim 1, wherein the first sealing ring comprises a sealing body, a plurality of first annular protrusions, and a plurality of second annular protrusions;
wherein the plurality of first annular protrusions are spaced apart on an exterior of the sealing body along a length direction of the first mounting hole, and the plurality of second annular protrusions are spaced apart on a hole wall of a through hole of the plurality of through holes along a length direction of the through hole.

4. The connector according to claim 1, wherein an inner circumferential wall of the second sealing ring is provided with a plurality of third annular protrusions, and an outer circumferential wall of the second sealing ring is provided with a plurality of fourth annular protrusions;
wherein the plurality of third annular protrusions are spaced apart along a length direction of the first mounting hole, and the plurality of fourth annular protrusions are spaced apart along the length direction of the first mounting hole.

5. The connector according to claim 4, further comprising a housing securely sleeved outside the insulating body;
wherein a gap is provided between the housing and the insulating body for the mating connector to be inserted into, and the housing is further provided with a plurality of exit holes for the first cables to pass through.

6. The connector according to claim 5, further comprising a third locking member, wherein the third locking member is inserted into the housing and is configured to lock the mating connector.

7. The connector according to claim 6, wherein a third fastener is disposed on an inner wall of the housing and is snap-fit into the mating connector, and the third locking member is configured to restrict the third fastener from disengaging from the mating connector.

8. The connector according to claim 1, further comprising a second terminal, wherein the insulating body is provided with a second mounting hole, and the second terminal is inserted into the second mounting hole.

9. The connector according to claim 8, further comprising a second locking member and a first locking member;
wherein a second fastener is disposed within the second mounting hole, first fasteners are disposed within the first mounting holes respectively, the second fastener is arranged to lock the second terminal at a preset position in the second mounting hole, and the first fasteners are configured to lock the first terminals at preset positions in the first mounting holes respectively;
wherein the second locking member and the first locking member are detachably inserted into the insulating body, and each of the second locking member and the first locking member has a pre-mounting position and a final locking position;
wherein the second locking member at the pre-mounting position is configured to allow the second terminal to be inserted into the second mounting hole, and the second locking member at the final locking position is configured to enable the second fastener to keep locking the second terminal; and
wherein the first locking member at the pre-mounting position is configured to allow the first terminals to be inserted into the first mounting holes or pulled out from the first mounting holes to make the first locking member at the final locking position lock the first terminals.

10. The connector according to claim 9, wherein the second mounting hole is provided with a third hole opening and a fourth hole opening that are arranged opposite to each other along a first direction; and
wherein the second locking member comprises a sleeve portion and an insertion portion, the sleeve portion is connected to the insertion portion and located outside the insertion portion, a clamping space having an opening facing the third hole opening is formed between the sleeve portion and the insertion portion, the insertion portion is inserted into the second mounting hole via the fourth hole opening, and the sleeve portion is sleeved on an outside of the insulating body.

11. The connector according to claim 10, wherein a step surface is formed at an end of the insertion portion inserted into the second mounting hole; when the second locking member is at the final locking position, the second fasteners abut against the step surface to define the final locking position of the second locking member; wherein a second stop surface is formed on a side of the second locking member facing the second terminal, the second stop surface gradually moves away from a hole wall of the second mounting hole from one end of the second stop surface facing the third hole opening to other end of the second stop surface facing away from the third hole opening, and a second abutting surface that fits into the second stop surface is formed on an outer wall surface of the second terminal; and
wherein an avoidance notch is formed on the sleeve portion, and the avoidance notch extends along the first direction to an end surface of the sleeve portion facing the second terminal.

12. The connector according to claim 11, wherein the first locking member comprises a connecting portion and two cantilever portions, the connecting portion extends along a second direction perpendicular to the first direction, and the two cantilever portions are formed on two opposite sides of the connecting portion along the second direction respectively and are perpendicular to the connecting portion so that the first locking member is U-shaped; and
wherein the cantilever portions are provided with interference relief grooves, when the cantilever portions are inserted into the insulating body until the first terminals are at the pre-mounting position, the interference relief grooves on the cantilever portions are in one-to-one correspondence with the first terminals; when the cantilever portions continue to be inserted into the insulating body until the first terminals are at the final locking position, the interference relief grooves avoid the first terminals to prevent the first terminals from moving toward the second hole openings.

13. The connector according to claim 12, wherein an outer wall of the insulating body is provided with two securing grooves extending along a third direction, the two securing grooves communicate with two rows of first mounting holes respectively, the two cantilever portions are inserted into the insulating body along the two securing grooves respectively, and the third direction is perpendicular to the second direction and the first direction;
wherein each of the two cantilever portions is provided with a second positioning block corresponding to a second slot hole disposed on a slot sidewall of the two securing grooves;
wherein the first locking member is further provided with a strip-shaped avoidance hole extending along the third direction;
wherein each of the cantilever portions further comprises a mounting portion and a locking portion that are L-shaped, the mounting portion and the locking portion are both connected to the connecting portion, the mounting portion is slidable in a securing groove, and the locking portion is inserted into the first mounting hole; and
wherein the second positioning block and the interference relief groove are provided on the mounting portion and the locking portion respectively, and the avoidance hole is also provided on the mounting portion.

14. The connector according to claim 13, wherein an operation hole communicating with an inner cavity of the housing is formed at a position of the housing corresponding to the connecting portion of the first locking member; and
wherein the housing is provided with a third slot hole, and the insulating body is provided with a third positioning block that is snap-fit into the third slot hole, the third positioning block is limited within the third slot hole to enable a detachable connection between the insulating body and the housing.

15. The connector according to claim 14, wherein the third fastener comprises a third elastic arm and a third recess, the third elastic arm is connected to the inner wall of the housing, and the third recess is disposed at an end of the third elastic arm extending toward the slot opening;
wherein a third locking block that is in a fit into the third recess is disposed on a mating connector, and the third locking block is configured to be locked into the third recess to lock the mating connector;
wherein two third elastic arms are provided and spaced apart along the third direction, the two third elastic arms are connected by a connecting rod so that the third recess is formed between the two third elastic arms, and the third locking block is locked into the third recess and abuts against the connecting rod;
wherein the third locking member is inserted into the housing from a closed end of the housing along the first direction, and the third locking member comprises a locking arm;
wherein an end portion of the locking arm of the third locking member at the pre-mounting position is located on a side of the connecting rod facing away from the opening of the housing, and the locking arm of the third locking member at the final locking position abuts against an outer side of the third fastener to prevent the third fastener from moving toward a side facing away from the third locking block; and
wherein the third locking member further comprises a sliding plate, and the sliding plate connects the locking arm and an end portion of the positioning arm located outside the housing.

16. The connector according to claim 15, wherein an outer wall surface of the second terminal is provided with a first recess, and the second fastener comprises a first elastic arm and a first locking block that are integrally molded;
wherein one end of the first elastic arm facing the third hole opening is connected to a hole wall of the second mounting hole, and the other end of the first elastic arm gradually moves away from the hole wall of the second mounting hole in the direction toward the fourth hole opening; and
wherein the first locking block is disposed on a side of the first elastic arm facing away from the hole wall of the second mounting hole, and the first locking block is snap-fit into the first recess.

17. The connector according to claim 16, wherein the second terminal comprises a front shielding shell and a rear shielding shell, and a rear end of the front shielding shell is sleeved on the rear shielding shell and crimped with the rear shielding shell; and
wherein the front shielding shell is provided with a small-diameter section and a large-diameter section in sequence in a reverse direction of the first direction, a first abutting surface is formed between the large-diameter section and the small-diameter section, the rear shielding shell is in a shape of a dumbbell, the first recess is an annular groove formed on the rear shielding shell, and the annular groove is located outside the front shielding shell.

18. The connector according to claim 17, wherein the first terminal is provided with a second recess, an avoidance groove, and a conical third abutting surface;
wherein the first fastener comprises a second elastic arm and a second locking block that are integrally molded, one end of the second elastic arm facing the first hole opening is connected to a hole wall of the first mounting hole, and the other end of the second elastic arm gradually moves away from the hole wall of the first mounting hole in the direction toward the second hole opening, and the second locking block is disposed on a side of the second elastic arm facing away from the hole wall of the first mounting hole and is snap-fit into the second recess;
wherein the avoidance groove is configured to avoid the first locking member when the first locking member moves along the third direction; and
wherein the third abutting surface is configured to abut against the third stop surface to prevent the first terminal from continuing to move toward the second hole opening.

19. The connector according to claim 8, wherein the plurality of first terminals are low-voltage terminals, and the second terminal is a terminal for transmitting an Ethernet signal.

20. A connector assembly, comprising the connector according to claim 1 and the mating connector mating with the connector.
